(19) United States
(12) Patent Application Publication
(10) Pub. No.: US 2007/0152973 A1
(43) Pub. Date: Jul. 5, 2007

(54) KEYBOARD FOR NOTEBOOK COMPUTER

(75) Inventors: Jun Zhang, Shenzhen (CN); Zheng Shi, Shenzhen (CN); Guang-Yao Lee, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/558,460

(22) Filed: Nov. 10, 2006

(30) Foreign Application Priority Data
Dec. 30, 2005 (CN) 200520121459.3

(51) Int. Cl. G06F 3/02

(52) U.S. Cl. 345/168

(57) ABSTRACT

A keyboard for a notebook computer includes a plurality of keys, and a touchpad positioned among the keys. This type of keyboard makes a full use of space of the notebook computer, and also is comfortable and matches demands of ergonomics.

### BACKGROUND OF THE INVENTION

1. Field of the Invention

The present invention relates to keyboards, and particularly to a keyboard for a notebook computer.

2. Description of Related Art

A typical notebook computer includes a base unit, and a cover unit pivotably connected to a rear end of the base unit. The base unit includes a top panel. The cover unit includes a screen. Generally, a keyboard is mounted to a rear side of the base unit of the notebook computer. A touchpad is mounted to a middle portion of a front side of the bottom panel neighboring the keyboard. The touchpad is touched by fingers of a user for moving a cursor displayed on a screen of the notebook computer or to select choices from menus displayed on the screen. However, regions of the top panel of the base unit, which are adjacent the touchpad at its left and right borders, are blank and have no any device disposed thereon. This is a waste of space, especially for a notebook computer which is tried to reduce a volume thereof.

What is desired, therefore, is a notebook computer having a keyboard which facilitates reducing size of the notebook computer.

### SUMMARY OF THE INVENTION

An exemplary keyboard for a notebook computer is provided. The keyboard includes a plurality of keys, and a touchpad positioned among the keys.

Other advantages and novel features will become more apparent from the following detailed description when taken in conjunction with the accompanying drawing, in which:

### BRIEF DESCRIPTION OF THE DRAWING

FIG. 1 is an isometric view of a notebook computer with a keyboard in accordance with a preferred embodiment of the present invention.

### DETAILED DESCRIPTION OF THE INVENTION

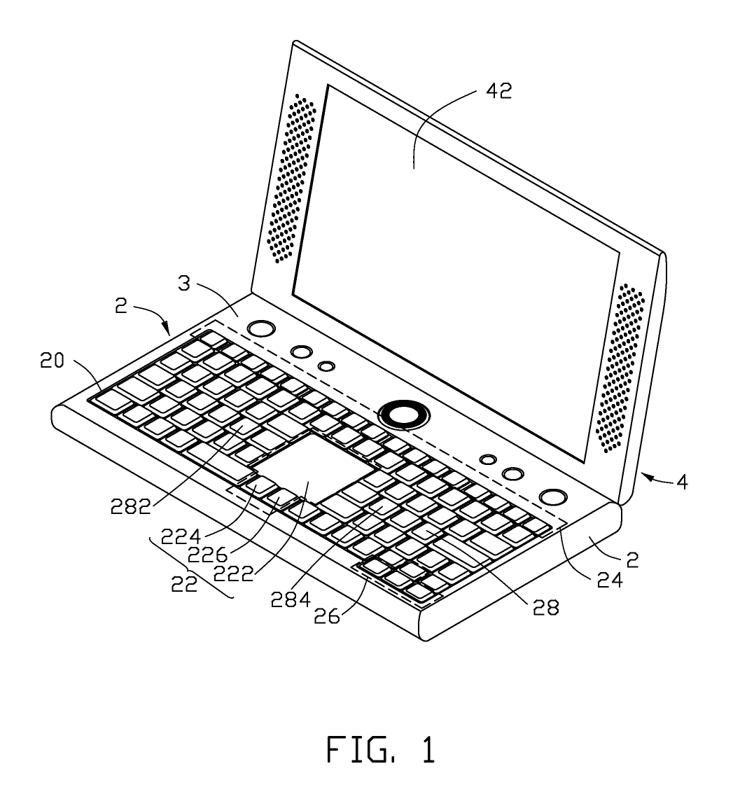

Referring to FIG. 1, a notebook computer in accordance with a preferred embodiment of the present invention is shown. The notebook computer includes a base unit 2 having a top panel 3, a cover unit 4 pivotably connected to a rear end of the base unit 2, and a keyboard 20. The cover unit 4 includes a screen 42. When the notebook computer is folded, the screen 42 faces the top panel 3 of the base unit 2. The keyboard 20 is mounted to the top panel 3 of the base unit 2. The keyboard 20 includes a plurality of keys, and a touchpad unit 22.

The keys of the keyboard 20 forms three regions 24, 26, 28. A first region 24 includes a plurality of function keys positioned in a line, adjacent a rear edge of the keyboard 20. The function keys respectively have different functions defined by a software stored in the notebook computer. A second region 26 includes four additional keys positioned in a corner of the keyboard 20. The additional keys are four arrow keys and configured for moving a cursor displayed on the screen 42 of the cover unit 4. A third region 28 includes a plurality of standard keys, which includes twenty six letter keys, ten numeric keys, and a plurality of control keys, such as “Space” key, “Enter” key, “Shift” key, and so on. An “F” key 282 and a “J” key 284 of the letter keys are positioning keys for forefingers of a user.

The touchpad unit 22 is positioned in the third region 28, that is, among the standard keys. The touchpad unit 22 includes a touch-sensitive touchpad 222, and two select switches 224, 226. The touchpad 222 is configured for moving a cursor displayed on the screen 42 of the cover unit 4. The switches 224, 226 are configured for selecting choices from menus or dragging files displayed on the screen 42.

In using the notebook computer, the positioning keys 282, 284 are controlled by forefingers of the user. The touchpad 222 of the touchpad unit 22 is easily accessed by movement of the forefingers. The switches 224, 226 are controlled by thumbs of the user. It makes the using of the touchpad unit 22 easy.

The touchpad unit 22 is positioned among the keys of the keyboard 20, such that the size of top panel 3 can be reduced to generally fit with the keyboard 20, thereby reducing a volume of the notebook computer. Furthermore, a distance between the “F” key 282 and “J” key 284 is larger than a distance in a typical keyboard, and close to a shoulder breadth of the user. The keyboard 20 is comfortable to use, and matches demands of ergonomics.

In other embodiments, quantity or positions of the keys on the keyboard 20 may be changed. The first region 24, the second region 26, and the third region 28 may be other shapes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A keyboard, comprising:
a plurality of keys; and
a touchpad positioned among the keys.

2. The keyboard as claimed in claim 1, wherein the keys comprise a plurality of standard keys, the touchpad is mounted among the standard keys.

3. The keyboard as claimed in claim 2, wherein the standard keys comprise twenty six letter keys, ten numeric keys, and a plurality of control keys.

4. The keyboard as claimed in claim 3, wherein the standard keys comprise two positioning keys, the positioning keys are positioned at opposite sides of the touchpad, respectively.

5. The keyboard as claimed in claim 2, wherein the keys further comprise a plurality of function keys

6. The keyboard as claimed in claim 5, wherein the function keys are positioned in a line, adjacent a rear edge of the keyboard.

7. The keyboard as claimed in claim 1, wherein two select switches are disposed under the touchpad.

8. A notebook computer, comprising:
a cover unit comprising a screen;
a base unit pivotably connected to the cover unit; and
a keyboard mounted to the base unit, the keyboard comprising a plurality of keys, and a touchpad positioned in an area defining by the keys.

9. The notebook computer as claimed in claim 8, wherein the keys of the keyboard comprise a plurality of standard keys, the standard keys comprise letter keys, numeric keys, and control keys, the touchpad is mounted among the standard keys.

10. The notebook computer as claimed in claim 9, wherein the twenty six letter keys comprise an “F” key and a “J” key, the “F” key and “J” key are positioned at two sides of the touchpad, respectively.

11. The notebook computer as claimed in claim 8, wherein the keys of the keyboard comprise a plurality of function keys positioned in a line, adjacent a rear edge of the keyboard.

12. The notebook computer as claimed in claim 8, wherein the keys of the keyboard comprise a plurality of additional keys positioned in a corner of the keyboard, the additional keys are configured for moving a cursor displayed on the screen of the cover unit to different positions of the screen.

13. The notebook computer as claimed in claim 8, wherein two select switches are arranged adjacent the touchpad, the select switches are configured for selecting choices from menus or dragging files displayed on the screen.
